(19) United States
(12) Patent Application Publication
(10) Pub. No.: US 2011/0098151 A1
(43) Pub. Date: Apr. 28, 2011

(54) HYBRID DRIVE TRAIN FOR A MOTOR VEHICLE AND METHOD FOR OPERATING THE HYBRID DRIVE TRAIN

(75) Inventor: Peter Ziemer, Tettnang (DE)

(73) Assignee: ZF FRIEDRICHSHAFEN AG, Friedrichshafen (DE)

(21) Appl. No.: 12/995,248

(22) PCT Filed: May 27, 2009
(86) PCT No.: PCT/EP2009/056422

§ 371 Date: Nov. 30, 2010

(30) Foreign Application Priority Data
Jun. 12, 2008 (DE) 10 2008 002 381.7

(51) Int. Cl. B60W 20/00; B60K 6/42; B60W 10/10; B60W 10/08

(52) U.S. Cl. 477/20; 180/65.22; 180/65.265; 903/930

(57) ABSTRACT

A hybrid drive train for a motor vehicle which comprises an combustion engine, at least two electric machines, a multi-gear transmission with transmission input and output shafts, a shift actuator, at least one energy storage device and a control unit arranged such that the combustion engine and the rotor of the first electric machine are connected to the transmission input shaft, and the transmission output shaft is connected either permanently or via a gearwheel arrangement or a chain or toothed-belt drive mechanism to at least one wheel or to a differential of a first vehicle axle. The rotor of the second electric machine is connected either permanently or via a chain or toothed-belt drive mechanism, either to at least one wheel or to a differential of the first vehicle axle, or to at least one wheel or to a differential of a second vehicle axle.

This application is a National Stage completion of PCT/EP2009/056422 filed May 27, 2009, which claims priority from German patent application serial no. 10 2008 002 381.7 filed Jun. 12, 2008.

### FIELD OF THE INVENTION

The present invention relates to a hybrid drive train for a motor vehicle. In addition the invention relates to a method for operating the hybrid drive train according to the invention.

### BACKGROUND OF THE INVENTION

From the prior art hybrid vehicles are known, which comprise a hybrid transmission having a basic transmission and a hybrid assembly, the hybrid assembly as a rule replacing a hydrodynamic torque converter. In addition to the internal combustion engine they comprise at least one electric motor or electric machine, which can operate as a motor or as a generator depending on the operating situation. In series hybrid vehicles, a generator is driven by the internal combustion engine and the generator then supplies electrical energy to the electric motor which powers the wheels.

Furthermore parallel hybrid vehicles are known, in which the torques of the internal combustion engine and of at least one electric machine that can be connected to the internal combustion engine are added, preferably by means of a summation gear system, for example by means of a planetary transmission.

In this case the at least one electric machine can be connected to the belt drive or to the crankshaft of the internal combustion engine. The torques produced by the internal combustion engine and/or by the at least one electric machine are transmitted to the driven axle by a downstream transmission.

In addition so-termed ‘power-split’ hybrid drive trains are known, in which power branching takes place. Such drive trains comprise for example an internal combustion engine, two electric motors, a simple planetary gearset and a differential. In such cases the internal combustion engine only transmits drive torque power to the road when one electric motor is operating as a generator and can therefore apply a counter-torque. This generator-produced electric power is passed on directly to the further electric motor, which operates as a drive motor and thereby assists in the acceleration of the vehicle.

With regard to the performance and functional scope of hybrid drive trains, in the prior art a distinction is drawn between micro-hybrid, mild hybrid and fully hybrid.

In a micro-hybrid, the vehicle has an auto-start-stop function and braking energy recovery (i.e. recuperation) for charging the battery of the electric machine, which is not used for driving the vehicle.

In a mild hybrid, in addition to the properties of a micro-hybrid, the internal combustion engine is supported by the electric machine for increasing the power (boosting) or to improve efficiency.

With their electric motor power, fully hybrid vehicles can also be driven purely by an electric motor, including starting and accelerating.

As electric storage media for hybrid drive trains, preferably high-power batteries are used, in particular nickel-metal hybrid batteries that enable purely electric driving, or double-layer condensers with a high power density which can be rapidly charged and discharged.

Compared with previous drive train systems the use of hybrid drive trains is intended to improve driving performances and comfort, and/or to reduce fuel consumption and emissions.

Disadvantageously, however, driving and in particular constant driving under fully or partially electrically generated propulsion are less favorable in relation to consumption and emissions compared with propulsion powered purely by an internal combustion engine, provided that the internal combustion engine is operated in a rotational speed range which favors low consumption.

Another disadvantage of hybrid drive trains is that electric driving takes place by the feeding of originally fossil energy into the battery and its later recovery, processes which respectively involve significant losses. In addition, owing to the low energy density (around 5 Wh/kg) of the energy accumulator the weight of the vehicle is increased, which affects the consumption adversely. Furthermore, the structural complexity and hence the production and assembly costs of hybrid drive trains are high.

### SUMMARY OF THE INVENTION

The purpose of the present invention is to indicate a hybrid drive train which, while improving driving performances and preserving the comfort of an automatic transmission, enables consumption and emissions to be reduced and, as regards structural complexity, weight and costs, is more favorable compared with the known hybrid drive trains.

A further aim of the invention is to indicate a method for operating the hybrid drive train according to the invention.

Accordingly a hybrid drive train for a motor vehicle is proposed, which comprises an internal combustion engine, at least two electric machines, a multi-gear transmission which preferably engages with positive interlock and has a transmission input shaft and a transmission output shaft, a shift actuator, at least one electrical energy storage device and a control unit, power electronics and a sensor system, in which the internal combustion engine and the rotor of the first electric machine are connected permanently, or via a gearwheel arrangement or a chain drive or toothed-belt drive mechanism, jointly or individually, to the transmission input shaft of the multi-gear transmission, and the transmission output shaft of the multi-gear transmission is connected permanently or via a gearwheel arrangement, a chain drive or toothed-belt drive mechanism to at least one wheel or to a differential of a first vehicle axle, preferably the front axle. In addition the rotor of the second electric machine is connected either permanently or by means of a gearwheel arrangement, a chain drive or toothed-belt drive mechanism to at least one wheel or to a differential of the first vehicle axle, or to at least one wheel or to a differential of a second vehicle axle.

Preferably, the multi-gear transmission is designed as a countershaft transmission; in particular the countershaft transmission can be designed as or similarly to a slide-key transmission, or can comprise unsynchronized claw clutches. According to the invention the shift actuator is preferably designed with an electric motor. Moreover, besides automatic shift actuation manual gear selection is also possible.

Advantageously, in the multi-gear transmission unsynchronized claw clutches can be provided for one or more gears.

To achieve shorter gearshift times, synchronizers can be provided for one or more gears. Furthermore, the first electric machine can be located ahead of the internal combustion engine so that, viewed in the force flow direction, the internal combustion engine is between the first electric machine and the transmission. It can also be provided that the first and/or the second electric machine can be disengaged by means of a shift element, preferably by a claw clutch, whereby drag torques are further reduced.

According to the invention, the at least one energy storage device is preferably made in the form of a double-layer condenser.

In an advantageous further development of the invention a torsion damper can be arranged between the internal combustion engine and the transmission input shaft; further, a third electric machine can be arranged on the first vehicle axle, this third electric machine being positioned between a differential and a drive wheel, and the second electric machine between the differential and the other drive wheel, in each case connected either permanently or via a gearwheel arrangement or a chain drive or toothed-belt drive mechanism.

Advantageously the internal combustion engine and the electric machines can be fitted transversely to the driving direction, whereby a substantial efficiency improvement can be achieved by omitting a power deflection means.

According to a further development of the invention a third electric machine and the second electric machine, or a fourth electric machine, can be arranged on the second, preferably the rear vehicle axle, the rotor of the third electric machine being connected to one drive wheel and the rotor of the second or the fourth electric machine being connected to the other drive wheel of the second vehicle axle, in each case either permanently or via a gearwheel arrangement or a chain drive or toothed-belt drive mechanism. In this way a torque vectoring hybrid is created, in which the displacement of torque from one wheel of the axle to the other wheel is enabled.

Furthermore, it can be provided that the countershaft transmission has a second transmission output shaft arranged parallel to the first transmission output shaft, whereby higher torques and/or a shorter structural length can be achieved; in this case torque transmission takes place via spur gears arranged on each of the transmission output shafts, that mesh with a spur gear which, in turn, is connected to a further drive output such as a differential.

In the drive train according to the invention the first gear can be designed as an enabler gear, i.e. with torque limitation.

The concept according to the invention enables a starting clutch, frictional shift elements and synchronization devices to be omitted, since the driving phases in which the frictional shift elements are operated with speed differences, i.e. so that they generate heat and thus consume energy, namely starting off, crawling, maneuvering and gear-shifting, are implemented by the electric machines, the electrical energy being provided either by the first electric machine and/or by the electrical energy storage device.

Moreover, by refraining from longer journeys under consumption-favorable, purely electric drive power, instead of heavy, high-capacity batteries it is possible for example to use rapidly charging and discharging double-layer condensers.

In addition, according to the invention a parking lock and an additional reverse-gear device can be omitted, as will be explained below.

Furthermore, particularly in smaller motor vehicles, the hydraulic system and hydraulic pumps can be omitted if the shift actuation for engaging or disengaging gears takes place by electric motor means.

By omitting the components mentioned above, structural complexity, weight and costs are advantageously reduced substantially and at the same time fuel consumption is decreased and driving performances are improved.

According to the invention, without an explicitly constructed parking lock mechanism the parking lock function is realized by engaging a gear in the transmission, and this parking lock can be released, i.e. the gear disengaged, by applying a torque in the uphill direction to relieve the load on the drive train, by means of the second electric machine.

For the purpose of direct starting the internal combustion engine can be started by the first electric machine with no gear engaged; furthermore, it is provided according to the invention that the functions of electric starting, maneuvering and crawling forward and in reverse—wherein driving in reverse can be carried out without any additional reverse gear mechanism—can be implemented with no gear engaged by the second electric machine which, during this, is supplied from the at least one electrical energy storage device and/or by the first electric machine operating as a generator, which is in turn driven as a generator by the internal combustion engine.

As regards the method for operating the hybrid drive train according to the invention, continued driving takes place under the power of the internal combustion engine or the internal combustion engine with electric support (boosting) by engaging gears in the shift transmission, with a synchronous speed between the transmission input shaft and a loose wheel arranged on the shaft.

Moreover, driving can be carried out with electrical support with energy from the energy storage device and/or by operating the first electric machine as a generator by means of the second electric machine, or with energy from the at least one energy storage device while operating both electric machines as motors.

According to the invention the internal combustion engine can be started and kept running while at the same time starting forward with a gear, preferably the first gear engaged, by operating the first and/or the second electric machine as a motor, and driving can continue under the power of the internal combustion engine or the internal combustion engine with electrical support and a gear engaged; theoretically the motor can also be stalled and then restarted in this way.

During power upshifts or power downshifts the load is taken up partially or completely by the second electric machine, which operates in traction as a motor and in thrust as a generator, while at the same time the stress in the engaged gear of the shift transmission is relieved by motor action on the part of the internal combustion engine and/or by the application of a positive or negative torque by the first electric machine.

This procedure provides a high degree of spontaneity, since the second electric machine can be energized for a short time during the load transfer, and the torque level can be determined for example by virtue of a driving resistance balance.

According to the invention, during power upshifts or power downshifts the gear in the shift transmission is disengaged in the load-free or almost load-free condition by operating an actuator.

Furthermore, during power upshifts or power downshifts the synchronous running between the transmission input shaft and the loose wheel of the higher or lower gear in the shift transmission arranged on the transmission shaft can be produced by accelerating the transmission input shaft by motor action on the part of the internal combustion engine and/or by the application of a torque by the first electric machine operating as a generator or motor, small gear intervals favoring a rapid speed adaptation to the speed of the transmission input shaft and hence also to that of the crankshaft. Here, however, rapid speed adaptation is not strictly necessary because during the shift the drive torque is provided at the drive axle by the second electric machine.

A new gear can be engaged in the shift transmission during power upshifts or power downshifts, on the one hand with a slight speed difference between the transmission input shaft and the loose wheel of the new gear arranged on this transmission shaft, for example by engaging a shifting claw to mesh. On the other hand a new gear can be engaged with a slight speed difference between the transmission input shaft and the loose wheel arranged on this transmission shaft, or with complete synchronization, such that the shift actuation takes place exactly at the moment when the two sets of driving teeth are positioned relative to one another so that there is a tooth-opposite-tooth gap-position, whereby meshing without frontal clashing is possible.

Advantageously, the (combustion-) engine brake can be neutralized by gear disengagement. Furthermore, recuperation by operating the first electric machine and/or the second electric machine as a generator with a gear engaged is possible, whereas in the case when no recuperation is required the energy storage device can be made smaller.

In addition coasting operation can be carried out by gear disengagement, or gear disengagement and subsequently stopping the engine. For braking the vehicle or rolling up to less than a given, specified speed or holding the vehicle steady, it is proposed that when the speed falls below a particular, specified value, depending on the driving program and the speed of the internal combustion engine, a downshift is carried out or the gear engaged is disengaged; this is done analogously to the procedure described for power upshifts or power downshifts.

According to an advantageous feature of the method for operating the drive train, oscillation damping by at least one electric machine can take place.

At least one electric machine can additionally be used as a resolver.

Furthermore, the internal combustion engine can be used as a speed indicator, particularly when it is connected rotationally rigidly to the transmission input shaft.

According to a further design feature of the invention a directed, rotationally rigid connection between the internal combustion engine and the transmission input shaft can be used to enable speed and angular position determination during ignition, which simplifies the engagement of a new gear.

It is particularly advantageous for the electrical energy produced by one electric machine to be used by the at least one further electric machine. For example, during a traction upshift the speed of the internal combustion engine or that of the rotor of the first electric machine must be “depressed”, whereby the first electric machine brakes the internal combustion engine and produces current that, in turn, drives the second electric machine which takes up the load of the upshift. In this way less energy is drawn from the electric storage device during an upshift.

### BRIEF DESCRIPTION OF THE DRAWINGS

Below, the invention will be explained in more detail with reference to the example illustrated by the attached figures, which show:

FIG. 1: Schematic representation of an embodiment according to the invention, of a hybrid drive train for a motor vehicle; and

FIG. 2: Schematic representation of a second embodiment according to the invention, of a hybrid drive train for a motor vehicle.

### DETAILED DESCRIPTION OF THE PREFERRED EMBODIMENTS

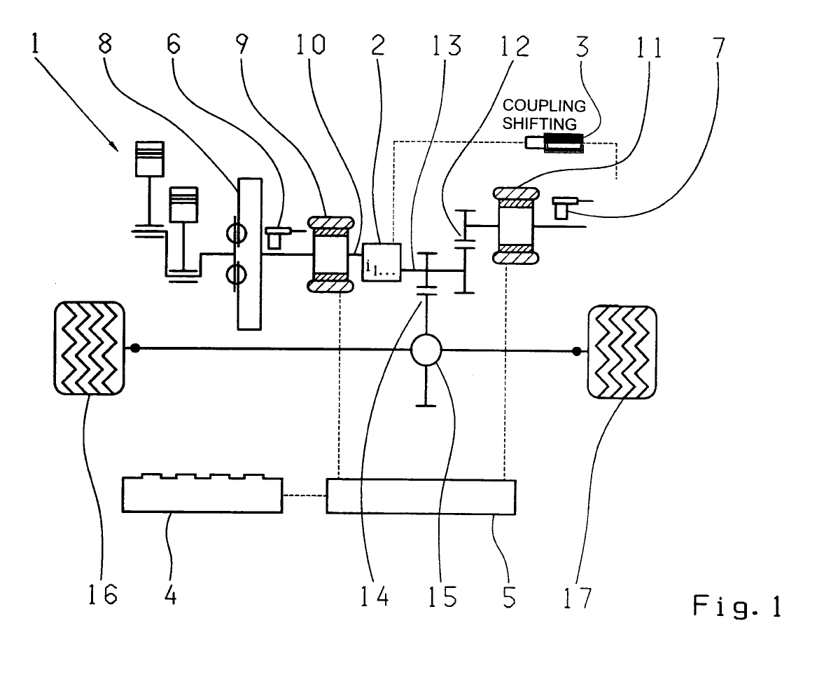

FIG. 1 shows a hybrid drive train comprising an internal combustion engine 1 mounted transversely at the front, two electric machines 9, 11, a transmission 2 with a plurality of gears, an electric-motor-driven shift actuator 3, double-layer condensers 4 as an energy storage device, and a control unit 5 with power electronics and speed sensors 6, 7 arranged ahead of and behind the transmission 2.

In the example shown in FIG. 1 the internal combustion engine 1 is connected, via a torsion damper 8, to the first electric machine 9, which is connected rotationally fixed to the transmission input shaft 10 of the transmission 2. According to the invention, the second electric machine is connected, via a spur gear arrangement 12, to the transmission output shaft 13 of the transmission 2.

Furthermore, the transmission output shaft 13 of the transmission 2 is connected by a spur gear arrangement 14 to a differential 15 for distributing the drive torque to the two front wheels 16, 17 of the motor vehicle.

The extra weight compared with a conventional drive train, caused by the use of the first electric machine instead of a conventional starter and a conventional generator, by the second electric machine, by the power electronics and by the double-layer condensers, is at least partially offset by the omission of the starting clutch, the synchronizers, the separate mechanism for producing the reverse gear and the shift actuator, and by the use of a smaller internal combustion engine.

With a short overall ratio of the first gear, which can for example amount to 21.5, and with a static tire rolling radius of 0.277 m, crawling speeds similar to those of a cross-country vehicle, of less than 5 km/h at 1000 r/min, can be achieved.

Typical values for the gear intervals are: 1.43 (1-2 gear), 1.40 (2-3 gear), 1.36 (3-4 gear), 1.32 (4-5 gear), 1.28 (5-6 gear), 1.25 (6-7 gear), 1.23 (7-8 gear), 1.20 (8-9 gear) and 1.19 (9-10 gear). Advantageously, owing to the small gear intervals and by virtue of the boosting, the acceleration capacity obtained is comparable to that of a conventional drive train with an engine power at least 1.3 times greater.

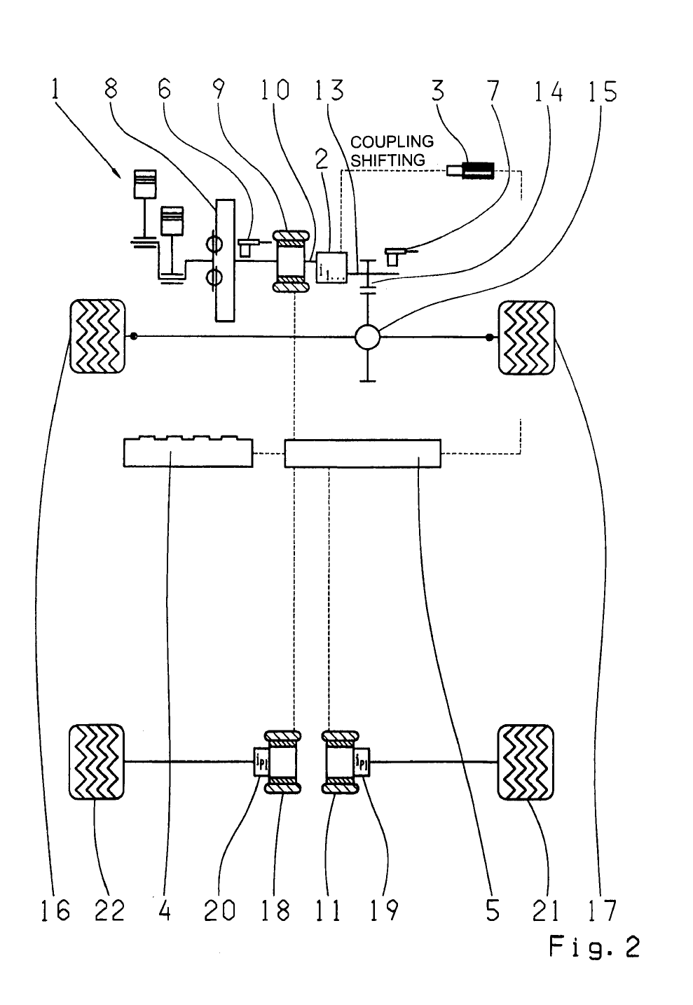

The drive train according to the invention can be extended to a torque vectoring version by the use of two electric machines 11, 18 in the form of a tandem electric machine on the rear axle of the vehicle, as illustrated in FIG. 2. In this case the second electric machine 11 is associated with a wheel 21 of the rear axle and connected to the rear axle by a gear arrangement 19. As can be seen from the figure a third electric machine 18, likewise connected to the control unit 5, is also provided, which is associated with the other wheel 22 of the rear axle and connected to the rear axle by a gear arrangement 20.

Of course, any design configurations and in particular any spatial arrangements of the components of the drive train according to the invention, in their own right and in relation to one another, to the extent that they are technically appropriate, fall within the protection scope of the present claims, without influencing the function of the drive train as indicated in the claims, even though such designs may not be represented explicitly in the figures or in the description.

### INDEXES

1 Internal combustion engine
2 Transmission
3 Shift actuator
4 Electrical energy storage device
5 Control system
6 Rotation speed sensor
7 Rotation speed sensor
8 Torsion damper
9 Electric machine
10 Transmission input shaft
11 Electric machine
12 Spur gear drive
13 Transmission output shaft
14 Spur gear drive
15 Differential
16 Front wheel
17 Front wheel
18 Electric machine
19 Gear arrangement
20 Gear arrangement
21 Wheel on the rear axle
22 Wheel on the rear axle

1-25. (canceled)

26. A hybrid drive train for a motor vehicle, the drive train comprising an internal combustion engine (1), at least first and second electric machines (9, 11), a multi-gear transmission (2) with a transmission input shaft (10) and a transmission output shaft (13), a shift actuator (3), at least one electrical energy storage device (4) and a control unit (5), and power electronics and sensors (6, 7),
the internal combustion engine (1) and a rotor of the first electric machine (9) being one permanently connected and connected by one of a gearwheel arrangement, a chain-drive mechanism and a toothed-belt drive mechanism, either jointly or individually, to the transmission input shaft (10) of the multi-gear transmission;
the transmission output shaft (13) of the multi-gear transmission being one of permanently connected and connected by a gearwheel arrangement (14), a chain-drive mechanism or a toothed-belt drive mechanism to one of at least a first drive wheel (16) and a differential (15) of a first vehicle axle; and
a rotor of the second electric machine (11) being one of permanently connected and connected by one of a further gearwheel arrangement, a chain-drive mechanism and a toothed-belt drive mechanism to at least one of the drive wheel, the differential (15) of the first vehicle axle, and a differential of a second vehicle axle.

27. The hybrid drive train for a motor vehicle, according to claim 26, wherein the multi-gear transmission is a countershaft transmission.

28. The hybrid drive train for a motor vehicle, according to claim 27, wherein the multi-gear transmission is a slide-key transmission.

29. The hybrid drive train for a motor vehicle, according to claim 26, wherein the multi-gear transmission comprises unsynchronized claw clutches for at least one gear.

30. The hybrid drive train for a motor vehicle, according to claim 26, wherein the first electric machine (9) is arranged before the internal combustion engine (1) such that, when viewed in a force flow direction, the internal combustion engine (1) is positioned between the first electric machine (9) and the multi-gear transmission (2).

31. The hybrid drive train for a motor vehicle, according to claim 26, wherein at least one of the first and the second electric machines (9, 11) is disengaged by a shift element.

32. The hybrid drive train for a motor vehicle, according to claim 26, wherein the at least one electrical energy storage device (4) is a double-layer condenser.

33. The hybrid drive train for a motor vehicle, according to claim 26, wherein a third electric machine is arranged on the first vehicle axle, the third electric machine is arranged between the differential (15) and the first drive wheel (16) and the second electric machine is arranged between the differential (15) and a second drive wheel (17) and , in each case, is connected thereto either permanently or by either a gearwheel arrangement, a chain-drive mechanism or toothed-belt drive mechanism.

34. The hybrid drive train for a motor vehicle, according to claim 26, wherein a third electric machine (18) and either the second electric machine (11) or a fourth electric machine are arranged on a second vehicle axle, and a rotor of the third electric machine (18) is connected to a first drive wheel (22) of the second vehicle axle and a rotor of the second or the fourth electric machine is connected to a second drive wheel (21) of the second vehicle axle, in each case either permanently or by a respective gearwheel arrangement (19, 20) or a chain-drive mechanism or a toothed-belt drive mechanism, such that a torque vectoring hybrid is created, in which torque displacement from the first drive wheel (22) of the second vehicle axle to the second drive wheel (21) is enabled.

35. The hybrid drive train for a motor vehicle, according to claim 26, wherein a torsion damper (8) is arranged between the internal combustion engine (1) and one of the first electric machine (9) and the transmission input shaft (10).

36. The hybrid drive train for a motor vehicle, according to claim 27, wherein the transmission (2) comprises a second transmission output shaft arranged parallel to the first output shaft, and the torque is transmitted via respective spur gears arranged on each of the first and the second transmission output shafts which mesh with a spur gear connected to a remainder of the drive output system.

37. A method for operating a hybrid drive train for a motor vehicle, the drive train comprising an internal combustion engine (1), at least first and second electric machines (9, 11), a multi-gear transmission (2) with a transmission input shaft (10) and a transmission output shaft (13), a shift actuator (3), at least one electrical energy storage device (4) and a control unit (5), and power electronics and sensors (6, 7), the internal combustion engine (1) and a rotor of the first electric machine (9) being one permanently connected and connected by one of a gearwheel arrangement, a chain-drive mechanism and a toothed-belt drive mechanism, either jointly or individually, to the transmission input shaft (10) of the multi-gear transmission; the transmission output shaft (13) of the multi-gear transmission being one of permanently connected and connected by a gearwheel arrangement (14), a chain-drive mechanism or a toothed-belt drive mechanism to one of at least a first drive wheel (16) and a differential (15) of a first vehicle axle; and a rotor of the second electric machine (11) being one of permanently connected and connected by one of a further gearwheel arrangement, a chain-drive mechanism and a toothed-belt drive mechanism to at least one of the drive wheel, the differential (15) of the first vehicle axle, and a differential of a second vehicle axle, the method comprising the steps of:
carrying out, via at least one of the first and second electric machine (9, 11), electric starting, maneuvering and crawling forward and in reverse without any gear engaged, the second electric machine (11), the second electric machine (11) being supplied from the at least one electrical energy storage device (4) and the first electric machine (9) operating as a generator, which is driven as a generator by the internal combustion engine (1).

38. The method for operating the hybrid drive train, according to claim 37, further comprising the step of either up starting or running the internal combustion engine (1) at the same time as starting off in the forward direction with a gear engaged, by operating at least one of the first and the second electric machine (9, 11) in a motor mode, and optionally, continuing driving under either internal combustion engine power or powered by the internal combustion engine with electric support with a gear engaged.

39. The method for operating a hybrid drive train, according to claim 37, further comprising the step of driving with electric support using energy from either at least one of the energy storage device (4) and operating the first electric machine (9) as a generator by the second electric machine (11) or from the at least one energy storage device (4) and with both electric machines (9, 11) operating as motors.

40. The method for operating a hybrid drive train, according to claim 37, further comprising the step of either partially or completely taking up load during at least one of power upshifts and power downshifts by the second electric machine (11), which operates as a motor during traction operation and as a generator during thrust operation while, at the same time, relieving stress in an engaged gear of the transmission (2) by motor action by at least one of the internal combustion engine (1) and application of either a positive or a negative torque by the first electric machine (9).

41. The method for operating a hybrid drive train, according to claim 37, further comprising the step of synchronizing the transmission input shaft (10) and a loose wheel of either a higher or a lower gear in the transmission (2) arranged on the transmission shaft during at least one of power upshifts and power downshifts by at least one of accelerating the transmission input shaft (10) by motor action of the internal combustion engine (1) and by the application of torque by the first electric machine (9) operating in at least one of a generator mode and a motor mode.

42. The method for operating a hybrid drive train, according to claim 37, further comprising the step of engaging a new gear in the transmission (2) during at least one of power upshifts and power down shifts when there is a slight speed difference between the transmission input shaft (10) and a loose wheel of the new gear arranged on the transmission shaft, by engaging a shifting claw so as to mesh, or engaging a new gear in the transmission (2) during at least one of power upshifts and power downshifts when there is a slight speed difference between the transmission input shaft (10) and the loose wheel of the new gear arranged on the transmission shaft or when there is complete synchronization, can take place if the shift actuation is performed exactly at the moment when the two driving teeth sets are located relative to one another in a tooth-opposite-tooth-gap position, whereby meshing is enabled without frontal clashing

43. The method for operating a hybrid drive train, according to claim 37, further comprising the step of implementing a parking lock function without any explicitly constructed parking lock by engaging a gear in the transmission, and the gear, is released by applying a torque in an uphill direction by the second electric machine (11) to relieve stress in the drive train.

44. The method for operating a hybrid drive train, according to claim 37, further comprising the step of carrying out coasting operation by one of gear disengagement and by gear disengagement and subsequently stopping the motor, whereby to brake the vehicle or to roll up to a given speed or hold the vehicle steady, when the speed has fallen below a particular value, a downshift is carried out or an engaged gear is disengaged, depending on a driving program and a speed of the internal combustion engine.

45. The method for operating a hybrid drive train, according to claim 37, further comprising the step of generating electrical energy with one electric machine which is used by the at least one other electric machine.

46. The method for operating a hybrid drive train, according to claim 45, further comprising the step of reducing the rotation speed of the internal combustion engine or the rotor of the first electric machine (9) during a traction upshift so that the first electric machine (9) brakes the internal combustion engine (1) and generates current that drives the second electric machine (11), which takes up the load of the upshift.

47. The method for operating a hybrid drive train, according to claim 37, further comprising the step of damping oscillation of the hybrid drive train by virtue of at least one electric machine.

48. The method for operating a hybrid drive train, according to claim 37, further comprising the step of utilizing at least one electric machine as a resolver.

49. The method for operating a hybrid drive train, according to claim 37, further comprising the step of utilizing a rotationally rigid connection between the internal combustion engine (1) and the transmission input shaft (10) to enable a speed and angular position detection by the ignition.

50. The method for operating a hybrid drive train, according to claim 37, further comprising the step of recuperating by generator operation of at least one of the first electric machine (9) with a gear engaged, and of the second electric machine.
